(19) United States
(12) Patent Application Publication
(10) Pub. No.: US 2011/0164049 A1
(43) Pub. Date: Jul. 7, 2011

(54) IMAGE SIGNAL DISTRIBUTION APPARATUS AND CONTROL METHOD THEREOF, AND PROGRAM

(75) Inventor: Masaaki Kobayashi, Kawasaki-shi (JP)

(73) Assignee: CANON KABUSHIKI KAISHA, Tokyo (JP)

(21) Appl. No.: 12/962,982

(22) Filed: Dec. 8, 2010

(30) Foreign Application Priority Data
Jan. 5, 2010 (JP) 2010-000792

(51) Int. Cl. G09G 5/02

(52) U.S. Cl. 345/589

(57) ABSTRACT

A distribution ratio required to distribute the luminance signal indicating the luminance value of the input image signal to the two display apparatuses is decided. In this decision, from current luminance values of projected images generated by the two display apparatuses based on a previous frame image held in a frame buffer memory, which holds the image signal for respective frames, and the luminance value of the input image signal, the distribution ratio which minimizes response times required to change the current luminance values of the projected images generated by the two display apparatuses to the luminance value of the input image signal is decided.

### BACKGROUND OF THE INVENTION

1. Field of the Invention

The present invention relates to an image signal distribution apparatus in an image composition display system, which distributes and outputs a single image signal to two display apparatuses, superimposes projected images from the two display apparatuses at the same position, and displays the projected images for the image signal.

2. Description of the Related Art

In a display device using liquid crystal, deterioration of a moving image response property is caused by a phenomenon that an orientation change of a liquid crystal element which decides a luminance level by transmitting light at the time of changing the luminance level takes much time, that is, a long time until the luminance level becomes stable is required.

As an image composition display system, a multi-projection system which projects a plurality of projected images using liquid crystal projectors by superimposing them at the same position is available. For example, Japanese Patent Laid-Open No. 2006-113326 improves the moving image response property using such multi-projection system. More specifically, a time difference is assured between image display timings of two projectors, and a light-off operation of a backlight of one projector and a light-on operation of a backlight of the other projector are repeated until a luminance level is changed and becomes stable. By executing such operations, a state during a luminance change is prevented from being displayed.

On the other hand, a display device using liquid crystal has nonlinear properties that a luminance falling time is faster than a rising time, a luminance change from white to black is quicker than a change between halftone levels (Toshiba Review Vol. 60 No. 7 (2005) High-image quality OCB liquid crystal technique). This is so-called a change from normally white to normally black.

The related art, which hides luminance rising/falling states by lighting off the backlight, suffers from a lowered time-integrated luminance value.

### SUMMARY OF THE INVENTION

The present invention provides an image signal distribution apparatus in an image composition display system, which can improve the moving image response property without lowering a projected luminance level, a control method thereof, and a program.

According to the first aspect of the present invention, there is provided an image signal distribution apparatus in an image composition display system, which distributes and outputs a single image signal to two display apparatuses, superimposes projected images from the two display apparatuses at the same position, and displays the projected images for the image signal, the apparatus comprising: a signal input unit adapted to input an image signal; a frame buffer memory adapted to hold the image signal for respective frames; and a decision unit adapted to decide a distribution ratio required to distribute a luminance signal indicating a luminance value of the image signal input by the signal input unit to the two display apparatuses; wherein the decision unit decides, from current luminance values of projected images generated by the two display apparatuses based on a previous frame image held in the frame buffer memory, and the luminance value of the image signal input by the signal input unit, the distribution ratio which minimizes response times required to change the current luminance values of the projected images generated by the two display apparatuses to the luminance value of the image signal input by the signal input unit.

According to the second aspect of the present invention, there is provided a control method of an image signal distribution apparatus in an image composition display system, which distributes and outputs a single image signal to two display apparatuses, superimposes projected images from the two display apparatuses at the same position, and displays the projected images for the image signal, the method comprising: a signal input step of inputting an image signal; and a decision step of deciding a distribution ratio required to distribute a luminance signal indicating a luminance value of the image signal input in the signal input step to the two display apparatuses; wherein in the decision step, from current luminance values of projected images generated by the two display apparatuses based on a previous frame image held in a frame buffer memory which holds the image signal for respective frames, and the luminance value of the image signal input in the signal input step, the distribution ratio, which minimizes response times required to change the current luminance values of the projected images generated by the two display apparatuses to the luminance value of the image signal input in the signal input step, is decided.

According to the third aspect of the present invention, there is provided a program which is stored in a non-transitory computer readable medium and makes a computer control to function as an image signal distribution apparatus in an image composition display system, which distributes and outputs a single image signal to two display apparatuses, superimposes projected images from the two display apparatuses at the same position, and displays the projected images for the image signal, the program making the computer function as: a signal input unit adapted to input an image signal; a frame buffer memory adapted to hold the image signal for respective frames; and a decision unit adapted to decide a distribution ratio required to distribute a luminance signal indicating a luminance value of the image signal input by the signal input unit to the two display apparatuses; wherein the decision unit decides, from current luminance values of projected images generated by the two display apparatuses based on a previous frame image held in the frame buffer memory, and the luminance value of the image signal input by the signal input unit, the distribution ratio which minimizes response times required to change the current luminance values of the projected images generated by the two display apparatuses to the luminance value of the image signal input by the signal input unit.

According to fourth aspect of the present invention, there is provided an image signal distribution apparatus in an image composition display system, which distributes and outputs a single image signal to two display apparatuses, superimposes projected images from the two display apparatuses, and displays the projected images for the image signal, the apparatus comprising: a input unit adapted to input an image signal; a holding unit adapted to hold the image signal for respective frames; and a distribution unit adapted to distribute a luminance signal indicating a luminance value of the image signal input by the input unit to the two display apparatuses; wherein the distribution unit differentiates luminance values of image signal distributed to the two display apparatuses so as to be response time required to change luminance value of image signal of a previous frame image held in the holding unit to luminance value of image signal output to the two display apparatuses, smaller than response time when luminance value of image signal input by the input unit is output to the two display apparatuses.

According to the fifth aspect of the present invention, there is provided a control method of an image signal distribution apparatus in an image composition display system, which distributes and outputs a single image signal to two display apparatuses, superimposes projected images from the two display apparatuses, and displays the projected images for the image signal, the method comprising: a input step of inputting an image signal; a holding step of holding the image signal for respective frames; and a distribution step of distributing a luminance signal indicating a luminance value of the image signal input in the input step to the two display apparatuses; wherein the distribution step differentiates luminance values of image signal distributed to the two display apparatuses so as to be response time required to change luminance value of image signal of a previous frame image held in the holding step to luminance value of image signal output to the two display apparatuses, smaller than response time when luminance value of image signal input in the input step is output to the two display apparatuses.

According to the sixth aspect of the present invention, there is provided a program which is stored in a non-transitory computer readable medium and makes a computer control to function as an image signal distribution apparatus in an image composition display system, which distributes and outputs a single image signal to two display apparatuses, superimposes projected images from the two display apparatuses, and displays the projected images for the image signal, the program making the computer function as: a input unit adapted to input an image signal; a holding unit adapted to hold the image signal for respective frames; and a distribution unit adapted to distribute a luminance signal indicating a luminance value of the image signal input by the input unit to the two display apparatuses; wherein the distribution unit differentiates luminance values of image signal distributed to the two display apparatuses so as to be response time required to change luminance value of image signal of a previous frame image held in the holding unit to luminance value of image signal output to the two display apparatuses, smaller than response time when luminance value of image signal input by the input unit is output to the two display apparatuses.

Further features of the present invention will be apparent from the following description of exemplary embodiments with reference to the attached drawings.

### BRIEF DESCRIPTION OF THE DRAWINGS

FIG. 1 is a block diagram showing the arrangement of an image composition display system according to the first embodiment;

FIG. 2 is a block diagram showing the detailed arrangement of an image signal distributor according to the first embodiment;

FIG. 3 is a flowchart showing output luminance decision processing by a luminance signal decision unit according to the first embodiment;

FIG. 4 is a graph showing the response property of a liquid crystal element of a liquid crystal projector according to the first embodiment; and

FIG. 5 is a block diagram showing an arrangement example of a PC having a multi-monitor output configuration according to the second embodiment.

### DESCRIPTION OF THE EMBODIMENTS

A preferred embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

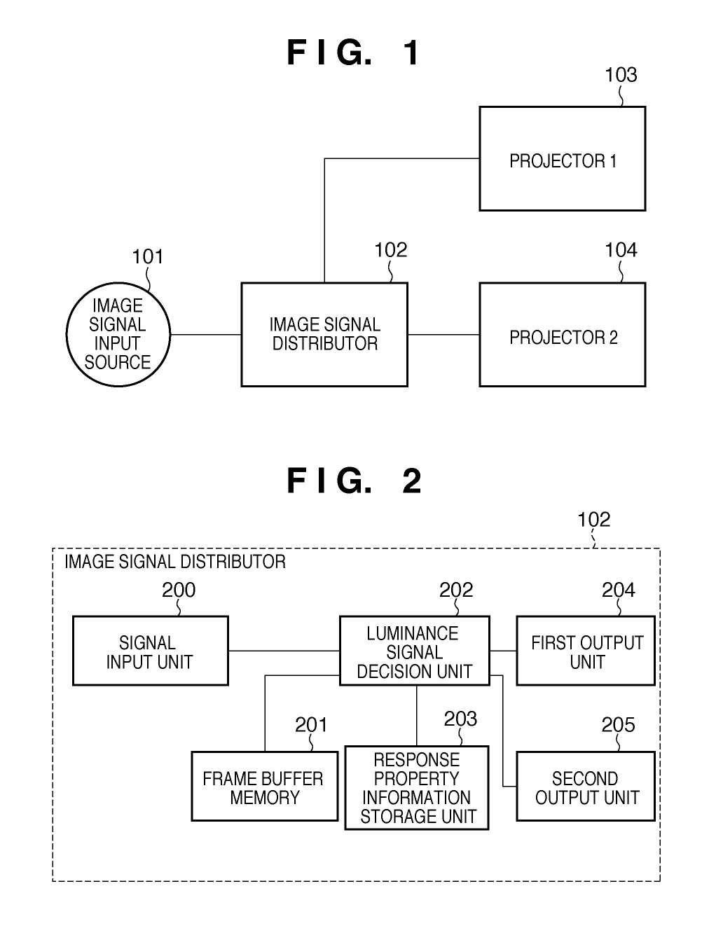

FIG. 1 is a block diagram showing the arrangement of an image composition display system according to the first embodiment.

In the image composition display system, reference numeral 101 denotes an image signal input source; 102, an image signal distributor; and 103 and 104, liquid crystal projectors (projectors 1 and 2) as display apparatuses. The image signal input source 101 outputs a single image signal as a moving image signal configured by frames to the image signal distributor 102. The image signal distributor 102 calculates two output luminance values from an input luminance value of the input image signal so as to shorten the response times of the liquid crystal projectors 103 and 104, and outputs them to the liquid crystal projectors 103 and 104, respectively. The two liquid crystal projectors 103 and 104 composite and project images by superimposing the output image signals (projected image signals) at the same position while synchronizing them for respective frames (to generate a composite image).

FIG. 2 is a block diagram showing the detailed arrangement of the image signal distributor according to the first embodiment.

In the image signal distributor 102 as the image signal distribution apparatus, reference numeral 200 denotes a signal input unit; 201, a frame buffer memory; 202, a luminance signal decision unit; 203, a response property information storage unit; and 204 and 205, first and second output units.

In this embodiment, assume that an output to the first output unit 204 will be referred to as a first output, and that to the second output unit 205 will be referred to as a second output. Also, let I(x, y, n) be a luminance value of an input signal at a coordinate position (x, y) of the n-th frame, O₁(x, y, n) be an output luminance value of a pixel at the coordinate position (x, y) of the n-th frame of the first output held in the frame buffer memory 201, and O₂(x, y, n) similarly be an output luminance value of the second output.

The response property information storage unit 203 has a response time information lookup table used to calculate output luminance values so as to shorten response times until a composite luminance value is obtained. The response time information lookup table calculates an output signal O₂ from a luminance value of an input signal and two luminance values I₁ and I₂ before change.

This calculation of the lookup table can be expressed by:

O₁=+LUT(Iᵢ, I₁, I₂) (1)

In this way, the response time information lookup table manages a response time required to change from a luminance value of a previous frame image (immediately preceding frame image) to that of a frame of interest (current frame image). In other words, the response time information lookup table manages a response time required to change (reproduce) from a current luminance value to a target luminance value.

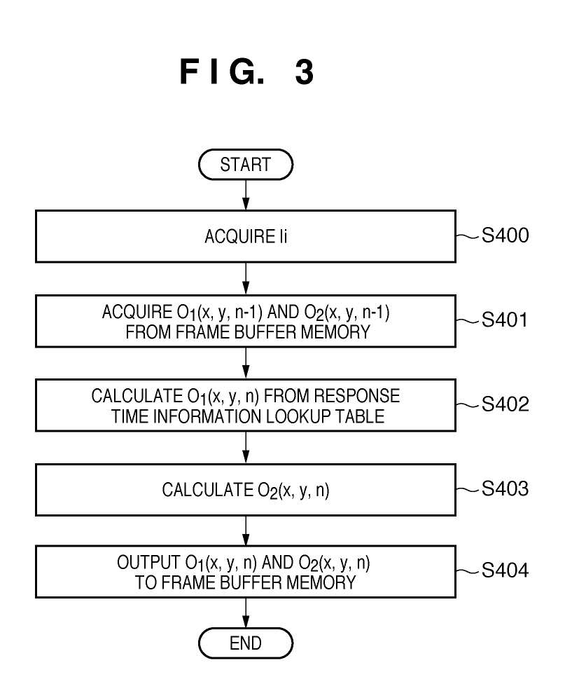

The signal input unit 200 inputs an image signal from the image signal input source 101, and outputs input luminance signal information of that signal to the luminance signal decision unit 202. The luminance signal decision unit 202 decides two luminance values O₁(x, y, n) and O₂(x, y, n) according to the sequence shown in FIG. 3, and outputs the decided luminance signals to the first and second output units 204 and 205. That is, the luminance signal decision unit 202 decides a distribution ratio required to distribute the input luminance signal to the first and second output units 204 and 205.

The first and second output units 204 and 205 convert the input luminance signals into image signals, and synchronously output these image signals to the external liquid crystal projectors 103 and 104.

FIG. 3 is a flowchart showing output luminance decision processing by the luminance signal decision unit according to the first embodiment. Note that processes to be described using FIG. 3 are executed for each pixel.

In step S400, the luminance signal decision unit 202 acquires Iᵢ. In step S401, the luminance signal decision unit 202 acquires luminance values O₁(x, y, n−1) and O₂(x, y, n−1) of pixels of the previous frames from the frame buffer memory 201.

In step S402, the luminance signal decision unit 202 calculates, using the response time information lookup table stored in the response property information storage unit 203, a luminance value O₁(x, y, n)=O₁ for the first output unit 204 in the frame of interest while setting I₁=O₁ (x, y, n−1) and I₂=O₂(x, y, n−1).

In step S403, the luminance signal decision unit 202 calculates, using equation (2) (O₂=Iᵢ×2−O₁), a luminance value O₂(x, y, n)=O₂ for the second output unit 205 in the frame of interest while setting Iᵢ=O₁.

In step S404, the luminance signal decision unit 202 outputs O₁(x, y, n) and O₂(x, y, n) to the frame buffer memory 201 for the processing of the next frame.

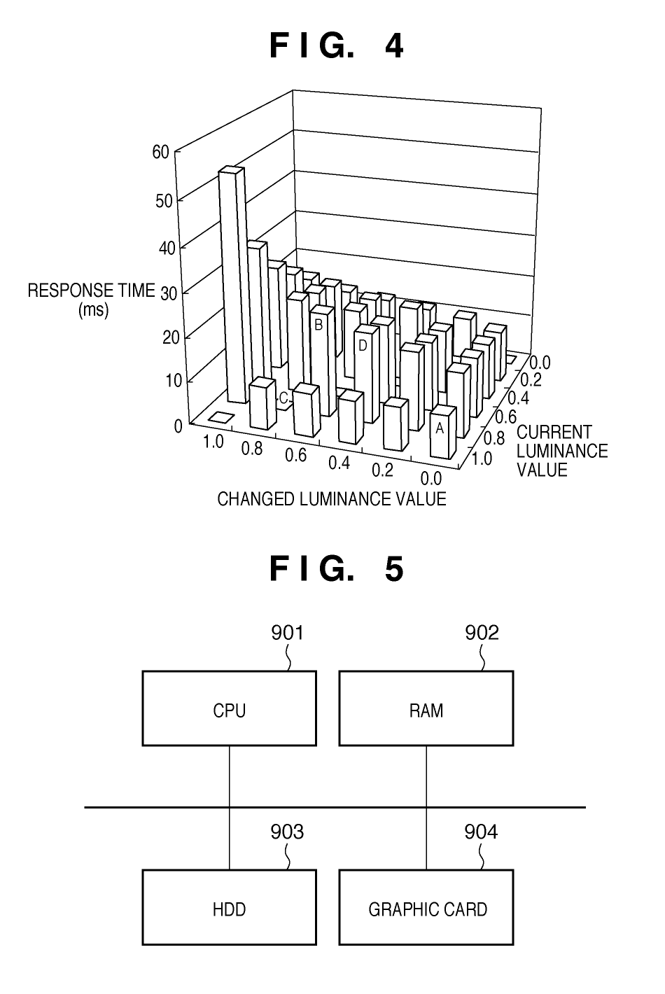

FIG. 4 shows the response property of a liquid crystal element of a liquid crystal projector according to the first embodiment.

For example, data A in FIG. 4 represents that a time of about 8 ms is required when a current luminance value “1.0” (white) changes to a luminance value “0.0” (black) after change (target luminance value). In this way, the response property (response time) of the liquid crystal element depends on the current luminance value and changed luminance value. When images are composited and displayed using two display devices (for example, the liquid crystal projectors 103 and 104), two output luminance values are required to be controlled.

When a signal Iᵢ=0.6 is input in a state in which O₁(x, y, n−1)=0.8 and O₂(x, y, n−1)=0.8, and when these luminance values are changed to assume the same value as the input signal, that is, O₁(x, y, n)=0.6 and O₂(x, y, n)=0.6 (B in FIG. 4), both pixels require a response time of about 24 ms.

By contrast, a combination of output luminance values (a distribution ratio of output luminance values) are optimized (selected) like O₁(x, y, n)=0.8 and O₂(x, y, n)=0.4 from a plurality of different combinations of output luminance values which can be distributed to the two display devices and can be assumed. In this case, a response time to O₁(x, y, n)=0.8 is 0 ms (C in FIG. 4), and that to O₂(x, y, n)=0.4 is about 22 ms (D in FIG. 4). At this time, a composite luminance value at the time of projection is equivalent to the above case. Since the liquid crystal element has such response property, if conditions that a sum of response times until a composite luminance value is obtained is minimized and Iᵢ×2=I₁+I₂ are set, the response time information lookup table which can shorten response times until a composite luminance value is obtained can be prepared.

Note that the first embodiment has described the preparation example of the response time information table using 5×5 luminance value data in 0.2-increments of luminance values. In this case, when the response time information table does not include an input luminance value as an index (for example, 0.5), linear interpolation is executed between given luminance values which sandwich the input luminance value, thereby calculating a response time for that luminance value.

As described above, according to the first embodiment, in the image signal distributor for the image composition display system, an image can be displayed to shorten response times until a composite luminance value is obtained.

Note that the system of the first embodiment has exemplified the liquid crystal projectors. However, the present invention is not limited to this. For example, the present invention may be applied to an image composition system which composites images of two FPDs on a single screen via a half mirror.

In the system of the first embodiment, the image signal distributor 102 is configured as a device independent of the two projectors. However, the image signal distributor 102 may be incorporated in the projector.

In the first embodiment, response time information stored in the response property information storage unit 203 is configured in the form of a lookup table. However, the present invention is not limited to this. For example, the response time property may be converted into a function, and coefficients of the function may be stored as the response time information.

As a response property improvement technique for a stand-alone display, an over-driving technique is known as a technique for determining whether a luminance value rises or falls with respect to a luminance value of a previous frame, and controlling a liquid crystal driving voltage to be high at the time of rising and to be low at the time of falling. In this case, the present invention is quite different from this over-driving technique, but the response information lookup table can be prepared in consideration of the over-driving technique.

### Second Embodiment

An embodiment of a method of shortening response times will be described below using FIGS. 1, 3, and 5.

The second embodiment uses a PC (personal computer) having a multi-monitor output configuration as the image signal distributor 102 in FIG. 1, and implements processing for implementing the present invention by software.

FIG. 5 is a block diagram showing an arrangement example of a PC having a multi-monitor output configuration according to the second embodiment.

A CPU 901 loads a program file and response time information lookup table recorded in an HDD (hard disk drive) 903 onto a RAM 902, and executes them. A graphic card 904 outputs two frames generated in a frame buffer memory in the RAM 902 to two external display devices (for example, liquid crystal projectors 103 and 104).

In this arrangement, the PC executes the output luminance decision processing in FIG. 3. The processing contents are as have been descried in the first embodiment. For example, the CPU 901 implements the function of the luminance signal decision unit 202.

In the second embodiment, image data loaded from the HDD 903 is processed. However, the present invention is not limited to this. For example, image data distributed from a network or a captured image can be processed as image data.

As described above, according to the second embodiment, in the distribution method for image composition display processing, an image can be displayed to shorten response times until a composite luminance value is obtained, as in the first embodiment.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-000792, filed on Jan. 5, 2010, which is hereby incorporated by reference herein in its entirety.

What is claimed is:

1. An image signal distribution apparatus in an image composition display system, which distributes and outputs a single image signal to two display apparatuses, superimposes projected images from the two display apparatuses at the same position, and displays the projected images for the image signal, the apparatus comprising:
a signal input unit adapted to input an image signal;
a frame buffer memory adapted to hold the image signal for respective frames; and
a decision unit adapted to decide a distribution ratio required to distribute a luminance signal indicating a luminance value of the image signal input by the signal input unit to the two display apparatuses;
wherein the decision unit decides, from current luminance values of projected images generated by the two display apparatuses based on a previous frame image held in the frame buffer memory, and the luminance value of the image signal input by the signal input unit, the distribution ratio which minimizes response times required to change the current luminance values of the projected images generated by the two display apparatuses to the luminance value of the image signal input by the signal input unit.

2. The apparatus according to claim 1, wherein the decision unit decides, as the distribution ratio, a combination of luminance values, which combination minimizes the response times, from a plurality of different combinations of luminance values, which can distribute the luminance value of the image signal input by the signal input unit to the two display apparatus, and can be assumed.

3. The apparatus according to claim 1, wherein the decision unit outputs the combination of the luminance values decided as the distribution ratio to the frame buffer memory.

4. The apparatus according to claim 1, further comprising:
a storage unit adapted to store response time information required to change luminance values that can be reproduced in projected images generated by the two display apparatuses to the luminance value of the image signal input by the signal input unit,
wherein the storage unit stores, as the response time information, a lookup table used to calculate response times required to change the current luminance values to the luminance value of the image signal input by the signal input unit, and
the decision unit decides the distribution ratio from the current luminance values of the projected images generated by the two display apparatuses based on the previous frame image held in the frame buffer memory, the response time information stored in the storage unit, and the luminance value of the image signal input by the signal input unit.

5. A control method of an image signal distribution apparatus in an image composition display system, which distributes and outputs a single image signal to two display apparatuses, superimposes projected images from the two display apparatuses at the same position, and displays the projected images for the image signal, the method comprising:
a signal input step of inputting an image signal; and
a decision step of deciding a distribution ratio required to distribute a luminance signal indicating a luminance value of the image signal input in the signal input step to the two display apparatuses;
wherein in the decision step, from current luminance values of projected images generated by the two display apparatuses based on a previous frame image held in a frame buffer memory which holds the image signal for respective frames, and the luminance value of the image signal input in the signal input step, the distribution ratio, which minimizes response times required to change the current luminance values of the projected images generated by the two display apparatuses to the luminance value of the image signal input in the signal input step, is decided.

6. A program which is stored in a non-transitory computer readable medium and makes a computer control to function as an image signal distribution apparatus in an image composition display system, which distributes and outputs a single image signal to two display apparatuses, superimposes projected images from the two display apparatuses at the same position, and displays the projected images for the image signal, the program making the computer function as:
a signal input unit adapted to input an image signal;
a frame buffer memory adapted to hold the image signal for respective frames; and
a decision unit adapted to decide a distribution ratio required to distribute a luminance signal indicating a luminance value of the image signal input by the signal input unit to the two display apparatuses;
wherein the decision unit decides, from current luminance values of projected images generated by the two display apparatuses based on a previous frame image held in the frame buffer memory, and the luminance value of the image signal input by the signal input unit, the distribution ratio which minimizes response times required to change the current luminance values of the projected images generated by the two display apparatuses to the luminance value of the image signal input by the signal input unit.

7. An image signal distribution apparatus in an image composition display system, which distributes and outputs a single image signal to two display apparatuses, superimposes projected images from the two display apparatuses, and displays the projected images for the image signal, the apparatus comprising:
a input unit adapted to input an image signal;
a holding unit adapted to hold the image signal for respective frames; and
a distribution unit adapted to distribute a luminance signal indicating a luminance value of the image signal input by the input unit to the two display apparatuses;
wherein said distribution unit differentiates luminance values of image signal distributed to the two display apparatuses so as to be response time required to change luminance value of image signal of a previous frame image held in the holding unit to luminance value of image signal output to the two display apparatuses, smaller than response time when luminance value of image signal input by the input unit is output to the two display apparatuses.

8. A control method of an image signal distribution apparatus in an image composition display system, which distributes and outputs a single image signal to two display apparatuses, superimposes projected images from the two display apparatuses, and displays the projected images for the image signal, the method comprising:
a input step of inputting an image signal;
a holding step of holding the image signal for respective frames; and
a distribution step of distributing a luminance signal indicating a luminance value of the image signal input in the input step to the two display apparatuses;
wherein said distribution step differentiates luminance values of image signal distributed to the two display apparatuses so as to be response time required to change luminance value of image signal of a previous frame image held in the holding step to luminance value of image signal output to the two display apparatuses, smaller than response time when luminance value of image signal input in the input step is output to the two display apparatuses.

9. A program which is stored in a non-transitory computer readable medium and makes a computer control to function as an image signal distribution apparatus in an image composition display system, which distributes and outputs a single image signal to two display apparatuses, superimposes projected images from the two display apparatuses, and displays the projected 7 images for the image signal, the program making the computer function as:
a input unit adapted to input an image signal;
a holding unit adapted to hold the image signal for respective frames; and
a distribution unit adapted to distribute a luminance signal indicating a luminance value of the image signal input by the input unit to the two display apparatuses;
wherein said distribution unit differentiates luminance values of image signal distributed to the two display apparatuses so as to be response time required to change luminance value of image signal of a previous frame image held in the holding unit to luminance value of image signal output to the two display apparatuses, smaller than response time when luminance value of image signal input by the input unit is output to the two display apparatuses.
